(19) United States
(12) Patent Application Publication
(10) Pub. No.: US 2015/0218017 A1
(43) Pub. Date: Aug. 6, 2015

(54) Methods for Reducing Ion Exchange and Reverse Salt Flux Phenomena in Membranes for Osmotically Driven Membrane Processes

(71) Applicant: Nagare Membranes, LLC, New York, NY (US)

(72) Inventor: Robert McGinnis, Coventry, CT (US)

(21) Appl. No.: 14/684,845

(22) Filed: Apr. 13, 2015

Related U.S. Application Data
(63) Continuation of application No. PCT/US2013/069714, filed on Nov. 12, 2013.
(60) Provisional application No. 61/725,026, filed on Nov. 12, 2012.

(51) Int. Cl. C02F 1/44; B01D 67/00; B01D 61/00; B01D 71/56

(52) U.S. Cl. CPC C02F 1/445; C02F 1/44; B01D 71/56; B01D 67/0093; B01D 61/002

(57) ABSTRACT

A method of modifying a semi-permeable osmotic membrane including treating the membrane to reduce at least one of an ion exchange and reverse draw solute flux phenomena in osmotically driven membrane process.

CROSS REFERENCE TO RELATED U.S. PATENT APPLICATIONS

The present application is a continuation of international application no. PCT/US2013/069714, filed Nov. 12, 2013, which application claims priority to U.S. Provisional Patent Application Ser. No. 61/725,026, entitled “Methods for Reducing Ion Exchange and Reverse Salt Flux Phenomena in Membranes for Osmotically Driven Membrane Processes” filed Nov. 12, 2012. The entire contents of the aforementioned international and provisional applications are incorporated herein by reference in their entireties.

### FIELD

One or more aspects relate to the formation or modification of semi-permeable membranes to reduce the occurrence of ion exchange and reverse salt flux phenomena, for use in osmotically driven membrane processes (“ODMPs”).

### BACKGROUND

The potential is significant for ODMPs to reduce the cost, and increase the efficiency and efficacy, of membrane separations and power production from osmotic pressure gradients. At the current state of development of these technologies, however, non-idealities continue to limit the full realization of this potential. One such non-ideality is found in the tendency for solutes on either side of a semi-permeable membrane, ideally a complete barrier to solute transport, to cross from one solution to another.

### SUMMARY

Methods of the various embodiments include modifying a semi-permeable osmotic membrane by treating the membrane to reduce at least one of an ion exchange and reverse draw solute flux phenomena in osmotically driven membrane process.

Devices of the various embodiments include a semi-permeable osmotic membrane having a polymer membrane material which is modified to reduce at least one or ion exchange and reverse draw solute flux.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1A is a cross-sectional flow diagram of a conventional forward osmosis membrane system.

FIG. 1B is a cross-sectional flow diagram of a conventional forward osmosis membrane system.

FIG. 1C is a cross-sectional flow diagram of a conventional forward osmosis membrane system.

FIG. 2A is a cross-sectional flow diagram of a forward osmosis system with a modified membrane.

FIG. 2B is a cross-sectional flow diagram of a forward osmosis system with a modified membrane.

FIG. 2C is a cross-sectional flow diagram of a forward osmosis system with a modified membrane.

FIG. 3 is a flow diagram of an embodiment method for modifying a membrane.

FIG. 4 is a flow diagram of an embodiment method for modifying a membrane.

### DETAILED DESCRIPTION

The various embodiments will be described in detail with references to the accompanying drawings. Wherever possible, the same reference numbers will be used throughout the drawings to refer to the same or like parts. References made to particular examples and implementations are for illustrative purposes, and are not intended to limit the scope of the disclosure or the claims. Alternate embodiments may be devised without departing from the scope of the disclosure. Additionally, well-known elements of the disclosure will not be described in detail or will be omitted so as not to obscure the relevant details of the disclosure.

The various embodiment methods and devices may include using a modified membrane in any of a number of osmotically driven membrane processes (ODMPs). Examples of such ODMPs may include forward osmosis (FO) and/or pressure enhanced osmosis (PEO) desalination or water treatment, pressure retarded osmosis (PRO) power generation, and direct osmotic concentration (DOC) of a desired feed stream constituent. In some ODMPs for which the embodiment recovery systems may be used, a first solution (known as a process or feed solution) may be seawater, brackish water, wastewater, contaminated water, a process stream, or other aqueous solution may be exposed to a first surface of the membrane. A second solution (known as a draw solution) with an increased concentration of solute(s) relative to that of the first solution may be exposed to a second opposite surface of the membrane.

The embodiments of the invention provide for the formation or modification of membranes for ODMPs, having characteristics that reduce or eliminate ion exchange and reverse draw solute flux phenomena. Methods of modifying membranes for ODMP to reduce or eliminate ion exchange and reverse draw solute flux phenomena include, but are not limited to: (1) chemically modifying surface functional groups of a forward osmosis (FO) membrane; (2) the addition of monomers or polymer chains to a surface of the membrane that modify its rejection characteristics; (3) coating the membrane with additional membrane materials; (4) combining different types of membranes together to achieve improved ion rejection performance over one alone; and/or (5) forming membranes that have improved ion and draw solute rejection inherent in their chemistry and/or structure.

Attributes of the membranes expected to reduce ion exchange effects include, but are not limited to:

(1) a surface charge which is neutral to slightly positive (e.g., with a zeta potential of zero or higher, such as approximately 0.1 to 5 mV), or strongly positive (e.g., with a zeta potential of approximately 5 to 20 mV), across a range of pH and ionic strength, due to a reduced tendency to form a layer of ions concentrating on a surface of opposite charge when neutral, and a reduced tendency to attract a layer of cations to the membrane surface when positive, the formation of which can increase ion exchange relative to anion accumulation;

(2) a surface which is slightly to moderately hydrophobic, due to its reduced tendency to attract cations in a double layer, due to differences in the degree of hydration between cations and anions (anions are often less hydrated, and therefore less attracted to hydrophilic surfaces, all else being equal), and the resulting differences in ion permeabilities due to differences in steric interactions between membrane polymer interstitial regions or other membrane permeation apertures, and the often smaller cation ionic radii;

(3) surfaces with smooth surface morphology, which reduces the surface area for charge accumulation relative to water permeation; and

(4) membrane apertures that are closely matched to the radius and or shape of water molecules, including, but not limited to, membranes composed of apertures or containing carbon nanotubes, graphene, aquaporin, or biomimetic synthetic water selective porous material meant to replicate aquaporin's function (e.g., pores that are big enough for water but not impurities). For example, PCT Published Patent Application No. WO 2010/002805 to Ratto et al. and U.S. Pat. No. 8,196,756 to Ratto et al. both disclose membranes containing carbon nanotubes for separating solutes from solvents in an osmotic process. Both the PCT Published Patent Application and the U.S. Patent are incorporated herein by reference in their entirety.

Operation of the ODMP membrane system at pH ranges and/or at ionic strengths that cause the membrane to exhibit one or more of these characteristics will also lead to increased effectiveness in reducing the non-ideality phenomena of ion exchange. Several of these attributes will also have the effect of reducing the non-ideality of reverse salt flux of draw solution solutes, particularly the attributes that increase water selectivity relative to solutes over all. In some cases, one or more desirable attributes will be reduced in order to increase other desirable attributes, as is needed to have the desired overall effect.

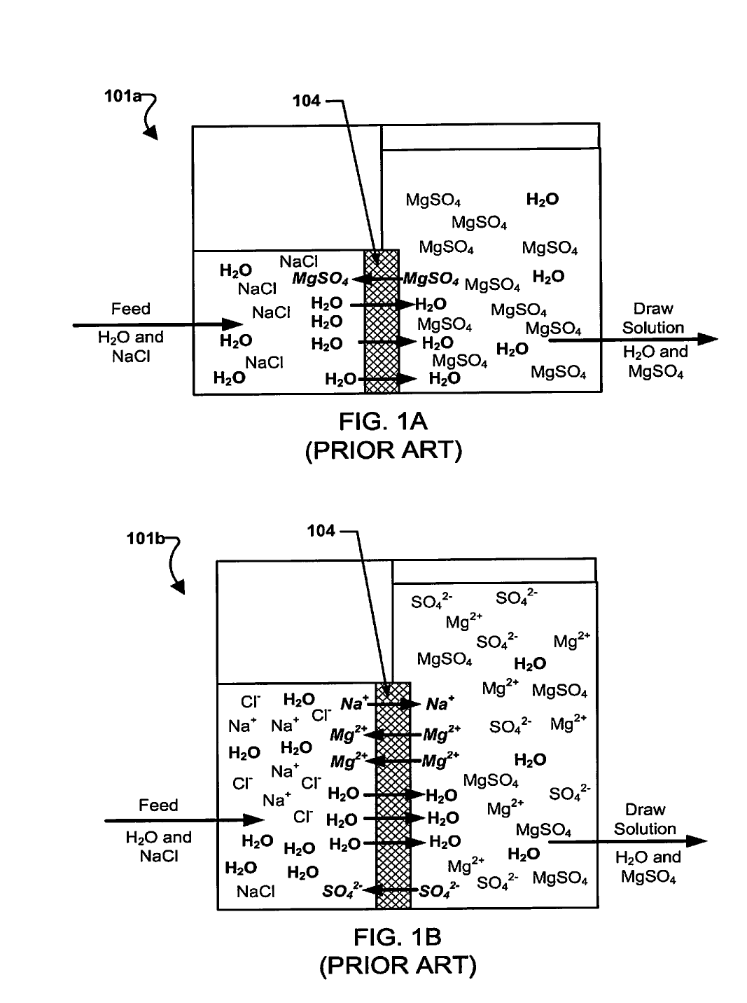

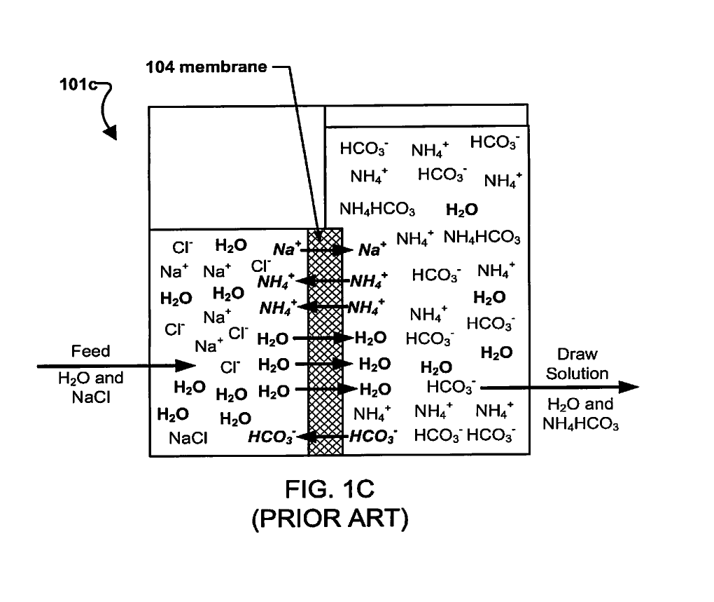

One example of a non-idealities phenomenon in an osmotically driven membrane process (ODMPs) is illustrated in FIG. 1A and includes the reverse salt flux of draw solution solutes from the draw solution into the feed solution. FIG. 1A illustrates a conventional membrane 104 in a forward osmosis (FO) process where draw solutes (e.g., MgSO₄) enter into the brine stream or feed stream containing water (H₂O) and sodium chloride (NaCl) requiring post treatment prior to disposal.

FIG. 1B illustrates a second example of these phenomena (e.g. ion exchange phenomena) where ionic species permeate across the conventional membrane 104. Specifically, FIG. 1B illustrates a feed solution containing water and sodium chloride and a draw solution containing water and magnesium sulfate (MgSO₄). Non-idealities in the forward osmosis process cause ions to pass through the conventional membrane 104. Here, sodium ions (Na⁺) are shown permeating through the membrane 104 from the feed solution to the draw solution, magnesium ions (Mg²⁺) are shown permeating through the membrane from the draw solution to the feed solution, and sulfate ions (SO4²) are shown permeating through the membrane from the draw solution to the feed solution.

Any one or all of the ion species may permeate across the membrane, which may occur without co-transport of their counter ions, as long as an equivalently charged ion or group of ions permeates in the opposite direction, maintaining electroneutrality in both solutions. In the case of ionic draw solutes, such as magnesium sulfate, a feed stream containing sodium chloride, might result in exchange of magnesium and sodium ions between the two solutions, relatively independently of an exchange of chloride and sulfate ions. In such a case, the composition of the draw solution will change over time, and may need to be secondarily treated or replaced, incurring higher system operating costs, including chemical (draw solute) consumption.

FIG. 1C illustrates a third example, which is similar to the second example, except that the draw solution comprises a thermally separable draw solute, namely ammonium bicarbonate (NH₄HCO₃). With ammonium bicarbonate as a thermally separable draw solute, ion exchange might comprise sodium (Na⁺) and ammonium ion (NH₄⁺) exchanges, as well as relatively independently, chloride (Cl⁻) and bicarbonate (HCO3⁻) exchange.

The ion exchange phenomena illustrated in FIGS. 1A-1C and described above can significantly increase the complexity of such a forward osmosis process. In the instance relating to FIG. 1C, the draw solutes (ammonium bicarbonate) may only be removed thermally when both the weak acid (carbonate species) and weak base (ammonium) ions are present in solution together. This requires additional separation steps on the brine and product water streams to bring these ions back into balance for thermal recovery, adding to the complexity and cost of to operating the ODMP system. In the instance relating to FIGS. 1A and 1B, the composition of the draw solution will change over time, and may need to be secondarily treated or replaced, incurring higher system operating costs, including chemical (draw solute) consumption.

In the case of direct osmotic concentration (DOC), this would introduce draw solutes into the product stream, where removal of such solutes could present special difficulties (in the case of sensitive enzymes, proteins, or compounds, for example). In the case of pressure retarded osmosis (PRO), this would introduce draw solutes into the working fluid, introducing internal concentration polarization in the membrane support structure, which has the effect of dramatically decreasing membrane power density, and requiring draw solute recovery from the working fluid, reducing system power conversion efficiency.

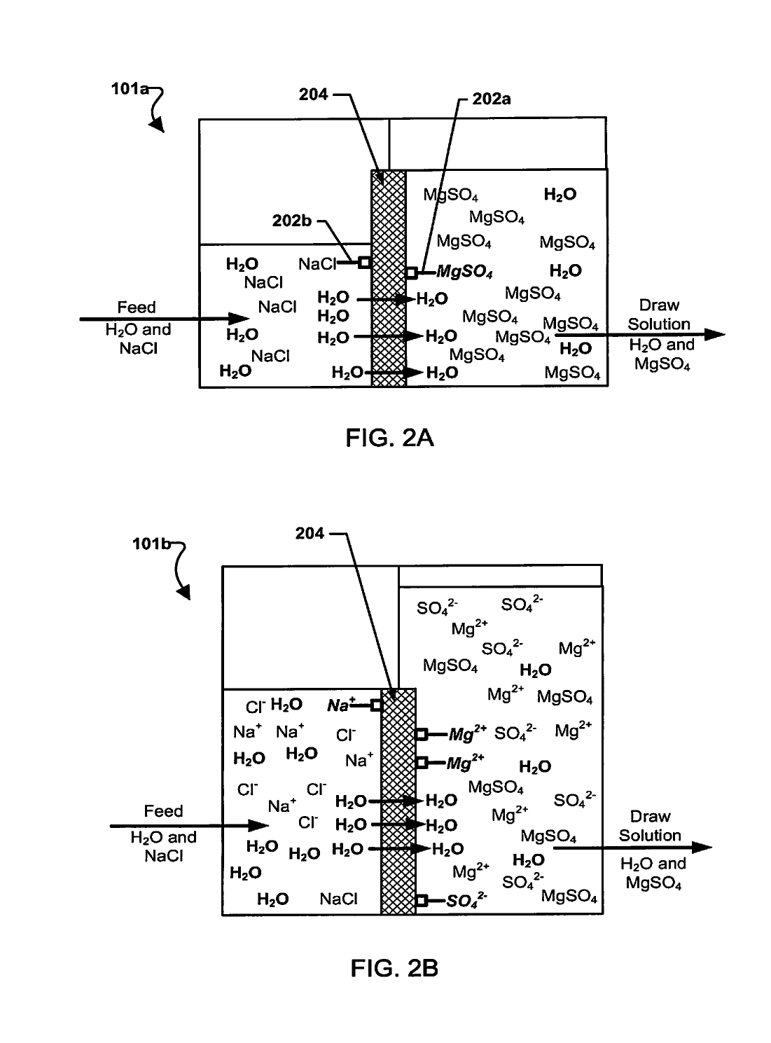

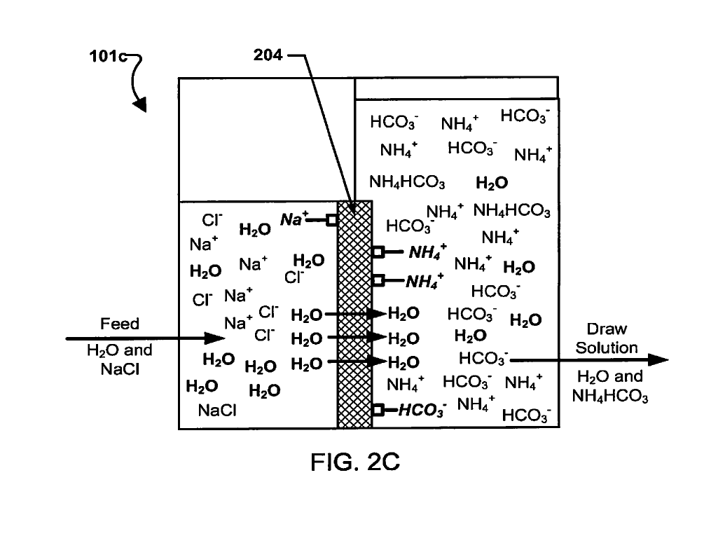

In the various embodiments modifying the membrane in an osmotically driven membrane process may prevent or reduce the problems outlined above and illustrated in FIGS. 1A-1C. In particular, FIGS. 2A-2C illustrate a modified membrane 204 with the identical feed and draw solutions as in FIGS. 1A-1C, respectively.

FIG. 2A illustrates a first solute's (e.g., sodium chloride in the feed stream) travel path 202b, whose permeation is rejected by the modified membrane 204. Similarly, the second solute's (e.g., magnesium sulfate draw solute in the draw solution) permeation through the modified membrane 204 is rejected. FIGS. 2B and 2C illustrate similar permeation rejections by the modified membrane 204 for sodium, magnesium, sulfate, ammonia, and bicarbonate ionic species. However, the membrane permits water permeation from the feed solution to the draw solution.

In accordance with one or more non-limiting embodiments, a semi-permeable membrane intended for use in ODMPs is subjected to chemical treatments that replace membrane functional groups, which include, by way of example, carboxyl functional groups, that have a tendency to deprotonate to produce a surface with a negative charge (e.g., with a zeta potential of less than zero, such as approximately −0.1 to −20 mV, for pH between approximately 4 and 10), with one or more other functional groups that do not exhibit the same tendency to deprotonate in the range of pHs typically employed in ODMPs, for example, acetyl or hydroxyl groups, resulting in a more neutral (e.g., with a zeta potential of zero or higher, such as approximately 0.1 to 5 mV), and/or less hydrophilic (e.g., increasing the contact angle of water to more than 62 degrees with a polyamide membrane, such as about 65 to about 75 degrees), and/or smoother surface.

Alternate embodiments include adding monomers, polymers, or other materials to a membrane surface, by various methods, including but not limited to: adsorption; covalent bonding; cross linking; dip coating; dynamic coating; or grafting, to create a layer at the membrane surface which has properties that reduce ion exchange and/or reverse solute flux, such as, but not limited to, neutral surface charge, and/or reduced hydrophilicity (e.g., increasing the contact angle of water with a polyamide membrane to more than 62 degrees), and/or increased surface smoothness. Such added materials may include, by way of non-limiting example, either as monomers, polymers, or side chains: polyelectrolytes; polyethyleneimine (PEI); polyvinyl alcohol (PVA); polyacrylic acid (PAA); sulfated polyvinyl alcohol copolymers (PVS); polyether ether ketone (PEEK); sulphonated polyetherether ketone (SPEEK); polyethylene glycol (PEG); polyethylene glycol polyacrylamide copolymers (PEGA); polyethylene glycol diacrylate (PEGDA); hydroxyethyl acrylate (HEA); arachidonic acid (AA); polydopamine; polyethylene oxide (PEO); surfactants; N,N-Dimethylaminoethyl methacrylate (DMAEMA); 2-acrylamido-2-methylpropane sulfonic acid (AMPS); natural organic matter (NOM); colloids; and/or nanomaterials, such as Buckminster Fullerene. Further treatments of the added materials may also be employed. In an embodiment, the materials are adsorbed to a membrane surface by electrostatic interaction, Van Der Waals forces, hydrogen bonding, and/or hydrophobic interaction.

Alternate embodiments include inducing cross-linking within the polymer chains of the membrane surface, to induce changes to the surface desirable for ion rejection. These include, by way of non-limiting example: UV radiation; plasma; acid or base treatment; cross-linking reagents; ion beam radiation; and/or redox initiation. Embodiments include a high degree of cross-linking, which may be measured by increased salt rejection.

Alternative embodiments include polyamide membranes that are formed by the interfacial polymerization of two monomers. Heating may induce a more complete reaction and the flushing of unreacted monomers. Further heating after the step of initial heating and flushing of unreacted monomers increases the degree of polymer cross-linking likely beyond that, which is optimal for reverse osmosis. However the further cross-linking (or heating) will provide a more optimal membrane for forward osmosis and pressure retarded osmosis.

Alternate embodiments include adding a second selective membrane material to the existing semi-permeable membrane. Non-limiting examples of this include adding water-permeable anion and/or cation selective membrane materials to the surface of polyamide membranes, cellulose acetated membranes, or other polymer membranes.

Alternative embodiments include adding one or more selective membrane layers to the semi-permeable membrane where the one or more selective membrane layers are at least one of a water permeable membrane, an anion selective membrane, a cation selective membrane, and a bilayer of an ion selective membrane.

Alternate embodiments include combining water-permeable anion and cation selective membranes in a double layer, sometimes referred to as bipolar membranes.

Alternate embodiments include using membranes in ODMP systems that use size exclusion and/or geometric and/or apertures requiring changing the orientation of passing species for selectivity of water over ions and/or draw solutes. By way of non-limiting examples, these include membranes comprising: carbon nanotubes; graphene; aquaporin; or biomimetic synthetic membranes performing similarly to aquaporin.

### Surface Charge Modification Embodiments

Surface charge modifications may change the surface charge of the membrane to prevent or reduce ion exchange and reverse salt flux phenomena. Optionally, this includes increasing the smoothness of a surface of the membrane itself. Five specific non-limiting embodiments of surface charge modifications are discussed below.

### Surface Charge Modification Embodiment 1

The first embodiment includes, coating the membrane surface by grafting, electrostatic deposition, or other methods, with cationic molecules, including by way of example, cationic polyelectrolytes, for example with polyethyleneimine (“PEI”). This coating process makes the surface positively charged (e.g., a zeta potential of between approximately 0.1 and 20 mV, depending on the pH of the solution in contact with the membrane) as well as making the surface of the membrane smoother. In an embodiment, PEI is adsorbed to a membrane surface by electrostatic interactions and/or Van Der Waals forces.

### Surface Charge Modification Embodiment 2

In a second embodiment, the surface of the membrane may be coated with polyvinyl alcohol (“PVA”). In contrast to the first embodiment, coating a surface of the membrane with PVA makes the membrane's surface less negative. Similar to the first embodiment, coating the surface for the membrane with PVA also makes the membrane's surface smoother. In an embodiment, PVA is adsorbed to a membrane surface by electrostatic interaction and/or Van Der Waals forces.

### Surface Charge Modification Embodiment 3

In a third embodiment, the surface of the membrane may be coated with chitosan, which is a linear polysaccharide composed of randomly distributed β-(1-4) linked D-glucosamine (deacetylated unit) and N-acetyl-D-glucosamine (acetylated unit). Similar to the first embodiment, coating the surface of the membrane makes the surface positively charged.

### Surface Charge Modification Embodiment 4

As a fourth embodiment, the surface of the membrane may be coated with either PEI or chitosan as described in embodiment 1 or 3. Then, the previously coated surface of the membrane may be coated with a molecule that is smooth and more neutral in charge. Some materials for this second coating step may include polyacrylic acid (PAA), polyvinyl sulfate (PVS) or sulfonated poly(ether etherketone) (SPEEK).

### Surface Charge Modification Embodiment 5

As a fifth embodiment, a surface membrane may be graft polymerized by free radical polymerization using polymers such as polyethylene oxide (PEO) and/or polyethylene glycol (PEG). Graft polymerization of positively charged molecules or neutral molecules (e.g., PEO, PEG) onto a membrane's surface makes that membrane's surface smoother. When grafting polymers, such as PEG, to the membrane's surface, the following embodiment techniques may be used including but not limited to grafting polymers to a membrane surface by ultraviolet (“UV”) radiation, redox initiation, and by use of oxygen plasma techniques. In various embodiments, grafting may include using additional reactants depending on the polymer used for grafting. The additional reactants may induce covalent bonds which permanently alters the membrane surface.

### Cross-Linking Embodiment

As an alternative approach to preventing or reducing ion exchange and reverse salt flux phenomena, a surface of the membrane or inner layers of the membrane may be cross-linked increasing the membrane's rigidity and selectivity and thereby reducing or preventing ion exchange and salt flux phenomena.

Specifically, the membrane may be heated to about 70-150° C. for about 15-30 minutes to increase cross-linking, thereby reducing reverse solute flux (RSF) and ion exchange (IX). Heating the membrane causes internal layers or materials to cross-link.

### Combination Embodiments

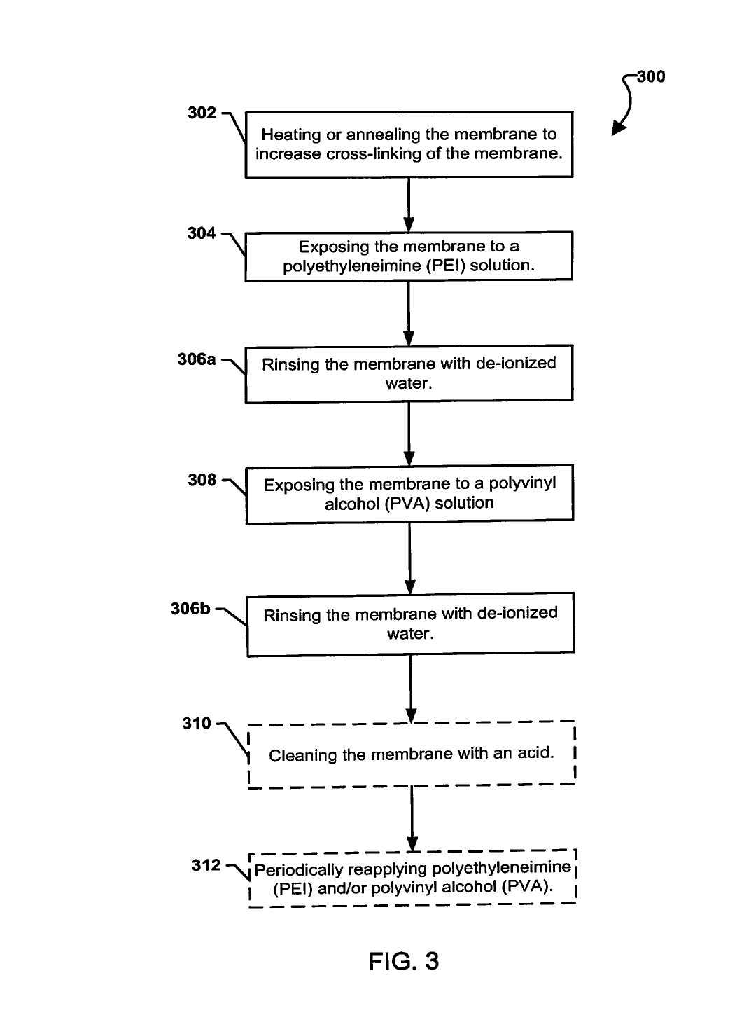

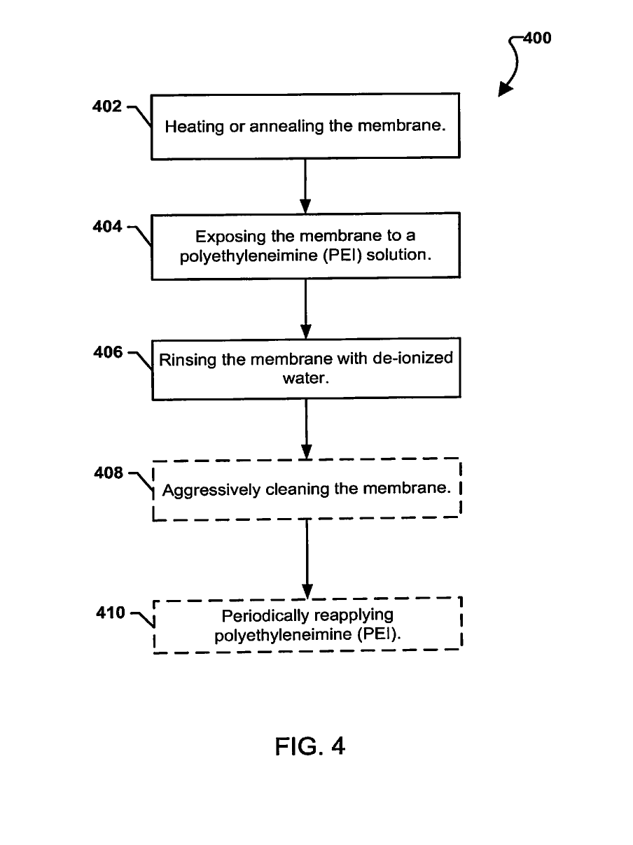

An embodiment method to increase the membrane's resistance to RSF and IX is discussed below in reference to method 300 of FIG. 3.

In block 302, the method includes heating or annealing the membrane. For example, the method may include heating or annealing the membrane to about 40-130° C. for about 10 minutes to about one hour to increase cross-linking. Preferably, the method includes heating or annealing the membrane to about 100° C. for about 30 minutes.

In block 304, the method includes exposing the membrane to a polyethyleneimine solution. The polyethyleneimine solution may comprise about 500 to about 1500 ppm of a polyethyleneimine. Preferably, the method includes exposing the membrane to a solution comprising about 1000 ppm of polyethyleneimine. Exposing the membrane to a polyethyleneimine solution may coat a surface of the membrane with polyethyleneimine comprising amine functional groups. The amine groups may exhibit a lower tendency to deprotonate on the surface of the membrane. This exposing process makes the surface positively charged as well as making the surface of the membrane smoother.

In block 306a, the method may include rinsing the membrane with de-ionized water (DI).

In block 308, the method may include exposing the membrane to a polyvinyl alcohol solution comprising about 20-100 ppm polyvinyl alcohol, preferably to a solution comprising 50 ppm polyvinyl alcohol. Exposing the membrane to a polyvinyl alcohol solution may coat the surface of the membrane with polyvinyl alcohol comprising hydroxyl groups. The hydroxyl groups may exhibit a lower tendency to deprotonate on the surface of the membrane.

In block 306b, the method may again include rinsing the membrane with deionized water. This may result in a smooth, neutral membrane surface over a more cross-linked membrane, that will reduce IX and RSF effects as illustrated in FIGS. 2A-2C.

In optional block 310, the method may include cleaning the membrane with an acid (e.g., hydrochloric acid, hydrobromic acid, formic acid, acetic acid, etc.)

In optional block 312, the method may include periodic re-application of PEI and/or PVA after acid cleaning.

The steps of blocks and optional blocks 302-312 maybe conducted or carried out in-situ with modules installed in a system.

### Alternate Embodiment

FIG. 4 illustrates an alternative embodiment similar to FIG. 3 except that the membrane is not exposed to a PVA solution in method 400.

In block 402, the method may include heating or annealing the membrane. For example the method may include heating or annealing the membrane to about 40-130° C. for about 10 minutes to about one hour. Preferably, the method includes heating or annealing the membrane to about 80° C. for about 30 minutes. Regardless of the exact temperature and timing, the heat application increases cross-linking of surfaces, layers, or other components internal to the membrane as illustrated in FIGS. 2A-2C.

In block 404, the method may include exposing the membrane to a PEI solution. The PEI solution may comprise 500 to 1500 ppm of PEI. Preferably, the method includes exposing the membrane to a solution comprising 1000 ppm of PEI. Exposing the membrane to a polyethyleneimine solution may coat a surface of the membrane with polyethyleneimine comprising amine functional groups. The amine groups may exhibit a lower tendency to deprotonate on the surface of the membrane. This exposing process makes the surface positively charged as well as making the surface of the membrane smoother.

In block 406, the method includes rinsing the membrane with deionized (“DI”) water. After heating the membrane, exposing the membrane to a PEI solution and rinsing the membrane with deionized water, the membrane should be smoother and have positively charged membrane surface over a more cross-linked membrane. These modifications to the membrane will reduce the ion exchange and reverse solute flow effects during forward osmosis operation of the membrane.

In optional block 408, the method may include aggressively cleaning the membrane. Aggressively cleaning the membrane may include exposing the membrane to a strong acid (e.g., hydrochloric acid) or weak acid (e.g., acetic acid). Aggressively cleaning the membrane may include multiple applications of an acid to the membrane followed by dilution or rinsing applications with deionoized water.

In optional block 410, the method includes periodic re-application of PEI after aggressive cleaning the membrane. The method steps of method 400 may be carried out in-situ with modules installed in a system.

Alternate embodiment: exposing the membrane to an amine terminated polymer.

In an embodiment, the membrane may be modified/treated by grafting a polymer containing neutral or positively charged groups to a surface of the membrane by using a linking reagent. Preferably, the method includes grafting a positively charged polymer having a reactive terminal group to the surface of the membrane by exposing the membrane to a linking reagent, and subsequently exposing the membrane to the positively charged polymer to graft the positively charged polymer onto the surface of the membrane by covalent bonding/attachment.

Preferably, the membrane comprises a polyamide membrane, exposing the membrane to the linking reagent comprises exposing the membrane to a carbodiimide solution, exposing the membrane to the positively charged polymer comprises exposing the membrane to a solution of an amine-terminated polymer having positively charged functional groups, such as at least one of NH₂ terminated PEI, spermine, N,N′-Bis(3-aminopropyl)-1,3-propanediamine, diethylenetriamine, pentaethylenehexamine or tetraethylenepentamine, and the positively charged polymer grafted onto the surface of the membrane comprises a positively charged polyamine. Thus, the polyamine is preferably grafted to the polyamide membrane surface using carbodiimide to cause covalent attachment of the polyamine to the polyamide membrane.

The embodiment method may include the following steps:

1) Exposing a polyamide membrane to approximately 0.01-0.45% carbodiimide solution (preferably about 0.1% carbodiimide solution) at a pH of about 2.0 to about 6.8 (preferably a pH of about 4.7 using a sodium citrate buffer) for about 1.5 hours to about 6 hours (preferably about 3 hours) at about 0-15 degrees Celsius (preferably, about 4 degrees Celsius).

2) Rinsing the polyamide membrane with de-ionized (“DI”) water.

3) Exposing the polyamide membrane to a solution of an amine-terminated polymer with positively charged functional groups (e.g., positive groups that often contain nitrogen) at about 0-15 degrees Celsius (preferably about 4 degrees Celsius) for about 12 to about 48 hours (preferably, about 24 hours). For example, the solution may comprise at least one of an NH₂ terminated PEI, spermine, N,N′-Bis(3-aminopropyl)-1,3-propanediamine, diethylenetriamine, pentaethylenehexamine or tetraethylenepentamine. However, this list is not exhaustive because the polyamide membrane may be exposed to a solution of amine-terminated polymer of any type that has positively charged groups for use with the carbodiimide reagent. Moreover, other reagents could be used with other types of polymers containing different terminal groups.

4) Rinsing the polyamide membrane a second time with de-ionized water.

The resulting membrane from the above steps (e.g., exposing the membrane to an amine terminated polymer) will have a permanently modified surface charge resulting in reduced ion exchange effects. This means that the resulting modified membrane surface will be more hydrophilic, but the change in surface charge will have desirable overall effects on ion exchange (e.g., reduce ion exchange across the membrane). Also, the modified membrane may be smoother depending on which polymer is exposed to the membrane and the conditions of the reaction (e.g., temperature and duration).

The polyamide membrane has negative charges through its thickness, and the polyamine “layer” grafted onto the membrane (e.g., polyamine sticking up from the surface of the membrane) has positive charges through its thickness. Natural organic matter will deposit negative charges on the surface of the grafted polyamine “layer” during normal use of the membrane. However, this still leaves positive charges in the thickness of the grafted “layer” to reduce or prevent cation exchange.

Tetraethylenepentamine (abbreviated as “TEPA”) described above has the following formula:

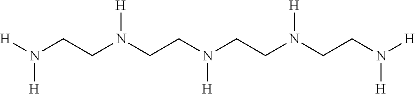 [SMILES: NCCNCCNCCNCCN]

Spermine described above has the following formula:

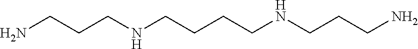 [SMILES: NCCCNCCCCNCCCN]

Diethylenetriamine described above has the following formula:

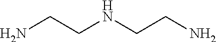

Pentaethylenehexamine described above has the following formula:

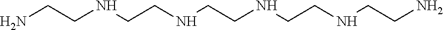 [SMILES: NCCNCCNCCNCCNCCN]

One of the terminal ends of these polymers will be covalently bonded to the polyamide membrane surface. The other end will be at the top of the polymer chain, which will be projecting from the surface of the membrane. The secondary amine groups are positively charged and tend not to deprotonate. Longer chains with similar structures would also work. Other polymers with different terminal groups (which would require a compatible reactive replacement for carbodiimide) and different positively charged groups may also be used. Branched polymers may also be used.

In an embodiment, the polyamide membrane may be heat treated prior to exposing the polyamide membrane to a solution of amine-terminated polymer with positively charged functional groups described directly above. The heating or heat treatment of the polyamide membrane may induce cross-linking within the polyamide structure so that the resulting modified polyamide membrane has a reduced reverse salt flux phenomena and ion exchange effects when operating in an osmosis driven process.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications (e.g. electrochemical energy devices), those skilled in the art will recognize that its usefulness is not limited thereto and that the present invention can be beneficially utilized in any number of environments and implementations where it is desirable to pass an electrical terminal through a sealed housing. Accordingly, the claims set forth below should be construed in view of the full breadth and spirit of the invention as disclosed herein.

What is claimed is:

1. A method of modifying a semi-permeable osmotic membrane comprising treating the membrane to reduce at least one of an ion exchange and a reverse draw solute flux phenomena in osmotically driven membrane process.

2. The method of claim 1, wherein:
the membrane comprises a polyamide material; and
the treating of the membrane comprises replacing negatively charged surface functional groups of the membrane with functional groups that have a lower tendency to deprotonate, such that a surface of the membrane that has a zeta potential below zero is converted to a surface that has a zeta potential of zero or above zero.

3. The method of claim 2, wherein:
the surface of the membrane that has a zeta potential ranging from about −0.1 mV to about −20 mV at a pH ranging from about 4 to about 10 is converted to the surface that has a zeta potential ranging from about 0.1 mV to about 20 mV; and
treating of the membrane comprises adding positively charged functional groups to the membrane.

4. The method of claim 3, wherein the treating of the membrane comprises replacing carboxyl functional surface groups of the membrane with functional groups that are more positive than the carboxyl functional groups.

5. The method of claim 4, wherein the treating of the membrane comprises replacing carboxyl functional surface groups of the membrane with acetyl functional groups, hydroxyl functional groups, or a combination thereof.

6. The method of claim 4, wherein treating of the membrane comprises:
exposing the membrane to a carbodiimide solution; and
exposing the membrane to an amine containing solution which comprises at least one or more of NH₂ terminated polyethyleneimine, spermine, N,N′-Bis(3-aminopropyl)-1,3-propanediamine, diethylenetriamine, pentaethylenehexamine, or tetraethylenepentamine, such that the membrane comprises positively charged polyamines grafted thereto.

7. The method of claim 1, wherein treating the membrane comprises adding molecules to the membrane to change is charge characteristics from negative to more neutral or positive.

8. The method of claim 7, wherein the added molecules comprise at least one or more of a polyelectrolyte, a polyethyleneimine, a polyvinyl alcohol, a polyacrylic acid, a sulfated polyvinyl alcohol copolymer, a polyether ether ketone, a sulphonated polyetherether ketone, a polyethylene glycol, polyethylene glycol polyacrylamide copolymer, a polyethylene glycol diacrylate, a hydroxyethyl acrylate, arachidonic acid, a polydopamine, polyethylene oxide, a surfactant, N,N-Dimethylaminoethyl methacrylate, and 2-acrylamido-2-methylpropane sulfonic acid.

9. The method of claim 1, further comprising adding to the membrane at least one of carbon nanotubes, buckminster fullerenes, graphene, aquaporin, or a biomimetic synthetic water selective porous material.

10. The method of claim 1, further comprising adding one or more selective membrane layers to the semi-permeable membrane.

11. The method of claim 1, wherein the treating of the membrane comprises chemically treating the semi-permeable membrane with at least one of an acid, a base, an organic reagent, an inorganic reagent, a reagent that modifies by a nucleophilic substitution reaction, and a reagent that modifies by a redox reaction.

12. The method of claim 1, wherein the treating of the membrane comprises cross-linking the membrane using at least one or more of heating, UV radiation, plasma, acid or base treatment, cross-linking reagent, ion beam radiation, or redox initiation.

13. A semi-permeable osmotic membrane comprising a polyamide membrane material that is modified to reduce at least one of ion exchange and reverse draw solute flux.

14. The membrane of claim 13, wherein at least one surface of the membrane has a zeta potential of zero or greater than zero.

15. The membrane of claim 14, wherein the at least one surface of the membrane has a zeta potential of about 0.1 mV to about 20 mV at a pH ranging from about 4 to about 10.

16. The membrane of claim 13, wherein carboxyl functional surface groups of the polyamide membrane are replaced with functional groups that are more positive than the carboxyl functional groups.

17. The membrane of claim 16, wherein carboxyl functional surface groups of the polyamide membrane are replaced with acetyl groups, hydroxyl functional groups, or a combination thereof.

18. The membrane of claim 13, wherein the polyamide membrane comprises a multilayer membrane.

19. The membrane of claim 18, wherein the membrane comprises a polyamide membrane and at least one of a water permeable membrane, an anion selective membrane, a cation selective membrane, or a bilayer of an ion selective membrane.

20. The membrane of claim 13, wherein the membrane further comprises at least one or more of carbon nanotubes, buckminster fullerenes, graphene, aquaporin, or a biomimetic synthetic water selective porous material.

21. The membrane of claim 13, wherein the membrane comprises positively charged functional groups and negatively charged functional groups.

22. The membrane of claim 13, wherein the membrane is configured to reject the permeation of positively and negatively charged ionic species, while permitting the permeation of water.

23. An osmotic purification method comprising:
applying a feed stream to a first side of a membrane;
applying a draw solution to an opposing second side of the membrane; and
drawing water through the membrane, from the feed stream to the draw solution, using an osmotically driven membrane process,
wherein at least one surface of the membrane has a zeta potential of zero or greater than zero

24. The method of claim 23, wherein:
the membrane comprises a polyamide membrane material; and
carboxyl functional surface groups of the membrane are replaced with acetyl groups, hydroxyl functional groups, or a combination thereof.

25. The method of claim 24, wherein at least one surface of the membrane has a zeta potential ranging from about 0.1 mV to about 20 mV at a pH ranging from about 4 to about 10.

26. The method of claim 23, wherein the membrane comprises a multilayer membrane.

27. The method of claim 26, wherein the membrane comprises a polyamide membrane and at least one of a water permeable membrane, an anion selective membrane, a cation selective membrane, or a bilayer of an ion selective membrane.

28. The method of claim 23, wherein the osmotically driven membrane process comprises forward osmosis, pressure enhanced osmosis, direct osmosis, or pressure retarded osmosis.

29. The method of claim 23, wherein the membrane further comprises at least one of carbon nanotubes, buckminster fullerenes, graphene, aquaporin, or a biomimetic synthetic water selective porous material.

30. The method of claim 23, wherein the membrane comprises positively and negatively charged functional groups configured to respectively reject the permeation of positively and negatively charged ionic species.
